(19) United States
(12) Patent Application Publication
(10) Pub. No.: US 2024/0313532 A1
(43) Pub. Date: Sep. 19, 2024

(54) METHOD AND SYSTEM FOR MANAGING ELECTRIC POWER GENERATION USING REINFORCEMENT LEARNING

(71) Applicant: SAUDI ARABIAN OIL COMPANY, Dhahran (SA)

(72) Inventors: Yaseen Alsaleh, Mubarraz (SA); Ali Alameer, Saihat (SA); Hussain Almarzouq, Alasdiqa (SA)

(73) Assignee: SAUDI ARABIAN OIL COMPANY, Dhahran (SA)

(21) Appl. No.: 18/184,337

(22) Filed: Mar. 15, 2023

(51) Int. Cl. H02J 3/00; G06Q 50/06; H02J 3/38

(52) U.S. Cl. CPC H02J 3/003; G06Q 50/06; H02J 3/381; H02J 3/004; H02J 2203/10; H02J 2300/10; H02J 2300/24; H02J 2300/28; H02J 2300/40

(57) ABSTRACT

A method may include obtaining power generation data for an electric power generation environment. The method may further include obtaining acquired weather data for the electric power generation environment. The method may further include determining predicted weather data for a predetermined time interval using a first artificial neural network and acquired weather data. The method may further include obtaining acquired power demand data based on the electrical loads for the electric power generation environment. The method may further include determining predicted power demand data for the predetermined time interval using a second artificial neural network and the acquired power demand data. The method may further include determining an action for an electric power agent based on an agent policy, the power generation data, the predicted weather data, and the predicted power demand data. The method may further include transmitting a command to implement the action.

### BACKGROUND

Electrical power grids may be monitored and controlled by various electrical devices and control systems implemented over different power plants and power substations. In order to provide meet the electrical demands of a particular power grid, various power plants must produce sufficient electrical power to match any electrical loads on the system. With renewable power sources such as solar energy and wind energy, the amount of electricity available from some electrical generators is not always known in advance as changes in weather may also affect electricity production.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method that includes obtaining power generation data for an electric power generation environment. The electric power generation environment includes various control systems coupled to various electrical generator devices and various sensors that determine various electrical loads. The electrical generator devices transmit electrical power over various power transmission lines to the electrical loads. The method further includes obtaining acquired weather data for the electric power generation environment. The method further includes determining, by a computer processor, predicted weather data for a predetermined time interval using a first artificial neural network and acquired weather data. The method further includes obtaining, using the sensors, acquired power demand data based on the electrical loads for the electric power generation environment. The method further includes determining, by the computer processor, predicted power demand data for the predetermined time interval using a second artificial neural network and the acquired power demand data. The method further includes determining, by the computer processor, an action for an electric power agent based on an agent policy, the power generation data, the predicted weather data, and the predicted power demand data. The electric power agent is a control system among the control systems. The method further includes transmitting, by the computer processor and to the control system, a command to implement the action during the predetermined time interval.

In general, in one aspect, embodiments relate to a system that includes various electrical generator devices that include a wind power device, a solar generator device, and a fossil fuel power device. The system further includes a power substation network coupled to the electrical generator devices. The power substation network includes various sensors that determine various electrical loads. The system further includes various control systems coupled to the electrical generator devices. The system further includes an electric power manager coupled to the control systems. The electric power manager includes a computer processor. The electric power manager performs a method that includes obtaining power generation data for an electric power generation environment comprising the electrical generator devices and the control systems. The electric power generation environment includes the control systems coupled to the electrical generator devices and the sensors. The electrical generator devices are configured to transmit electrical power over various power transmission lines to the electrical loads. The method further includes obtaining acquired weather data for the electric power generation environment. The method further includes determining predicted weather data for a predetermined time interval using a first artificial neural network and acquired weather data. The method further includes obtaining, using the sensors, acquired power demand data based on the electrical loads for the electric power generation environment. The method further includes determining predicted power demand data for the predetermined time interval using a second artificial neural network and the acquired power demand data. The method further includes determining an action for an electric power agent based on an agent policy, the power generation data, the predicted weather data, and the predicted power demand data. The electric power agent is a control system among the control systems. The method further includes transmitting, to the control system, a command to implement the action during the predetermined time interval.

In some embodiments, observation data is obtained regarding an electric power generation environment in response to an electric power agent performing an action. The observation data may include power generation data, acquired weather data, and acquired power demand data. A reward value may be determined using the observation data and a reward function associated with the electric power agent. An agent policy may be updated using a reinforcement learning algorithm to produce an updated agent policy. A control system may transmit a second command to implement an action by the electric power agent for a predetermined time interval. The action may be based on the updated agent policy and observation data. In some embodiments, fuel price data is obtained for operating various electrical generator devices. Observation data may include the fuel price data. The fuel price data may be used to update the agent policy to produce the updated agent policy. In some embodiments, a reward function is based on a cost of electric power generation for a respective time interval. An agent policy may be updated based on a cost of electric power generation for a predetermined time interval.

In some embodiments, an agent policy is an artificial neural network that includes an input layer, an output layer, and various hidden layers. An action may be determined by the output layer based on observation data that is input to the input layer. In some embodiments, various electrical generator devices include one or more wind power devices in a predetermined region. Acquired weather data may include wind data that are acquired using various wind sensors in the predetermined region. Predicted weather data may be determined using the wind data. In some embodiments, various electrical generator devices include one or more solar generator devices in a predetermined region. Acquired weather data may include solar data that are acquired using various solarimeters in the predetermined region. Predicted weather data may be determined using the solar data. In some embodiments, predicted weather data is determined using wind data for a predetermined region, solar data for the predetermined region, and temperature data for the predetermined region. In some embodiments, power generation data includes transmission line data, ramping data, and power reserve data.

In some embodiments, training data is obtained regarding various electric power agents. An agent policy may be updated using the training data and based on a loss function and a mismatch between the training data and observation data regarding one or more electric power generation operations for one or more predetermined time intervals. An updated agent policy may include various policy parameters that are adjusted based on the mismatch. In some embodiments, various electric power agent trajectories may be obtained using a replay buffer and regarding various electric power agents. A reward function may be updated based on training data using various machine-learning epochs. The training data may include various electric power agent trajectories. In some embodiments, an electric power generation environment is monitored using a supervisory control and data acquisition (SCADA) system. A command may be transmitted by a control server that is a master node in the SCADA system.

In light of the structure and functions described above, embodiments of the invention may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1 and 2 show systems in accordance with one or more embodiments.

FIG. 3 shows a flowchart in accordance with one or more embodiments.

FIGS. 4A and 4B show an example in accordance with one or more embodiments.

FIG. 5 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for determining actions for electrical power generation using reinforcement learning. For example, some embodiments address problems associated with electrical power generation, demand forecasting, and controlling electrical generator devices. In particular, reinforcement learning may be used to dynamically learn agent policies for various electric power agents in real-time based on practical constraints. In a deep reinforcement learning (DRL) architecture, for example, various states may be predicted for an electric power generation environment using various machine-learning models, such as artificial neural networks. Examples states may include the status of various electrical generator devices, power reserve and ramp requirements, the status of transmission lines, expected wind speeds, ambient temperatures, regional solar irradiance, and the availability of renewable energy sources. For a particular time interval, one artificial neural network may predict weather data for the time interval, while another artificial neural network may predict power demand data from electrical loads for the same time interval. Likewise, a deep reinforcement learning architecture may use the predicted data to determine actions for various electric power agents based on different agent policies in the DRL system.

In some embodiments, an agent policy is also a machine-learning model that is updated based on observation data acquired from an electric power generation environment. Examples of observation data may include actual power demand data, actual weather data, power generation data, and fuel price data. As such, a machine-learning model for an agent policy may be updated in a similar manner as performed by an epoch in a training operation for training other machine-learning models. Where an agent policy is an artificial neural network, for example, predicted weather data, predicted power demand data, and/or power generation data may be input data to an input layer of the artificial neural network. On the neural network's output layer, one or more actions may be determined for one or more electric power agents accordingly. Actions may be subsequently implemented within an electric power distribution network using commands or control signals to operate one or more electric generation devices. Examples of electrical generator devices may include a fossil fuel power device, a solar power generator, and/or a wind turbine power plant.

Furthermore, agents in past optimization systems might require a significant time learning an optimal agent policy. Depending on historical data availability, for example, an agent's actions may result in higher production costs for an electric power distribution network over an extended period of time while learning the optimal agent policy. Moreover, some agents also failed to experience enough scenarios with differing constraints in an online learning period to determine an optimal agent policy for real-world application with a classical optimization algorithm (e.g., a mathematical or dynamic programming algorithm). Classical optimization algorithms are typically model-based that may make them less flexible to unforeseen changes in an electric power generation environment. With deep reinforcement learning, electric power agents or a central managing authority may determine farsighted actions that minimize electricity generation costs over a specific time horizon. As such, some embodiments can maximize power generation resources using the prediction capabilities of deep learning while also implementing agent policies as trained black boxes that may be more accurate than traditional rule-based models.

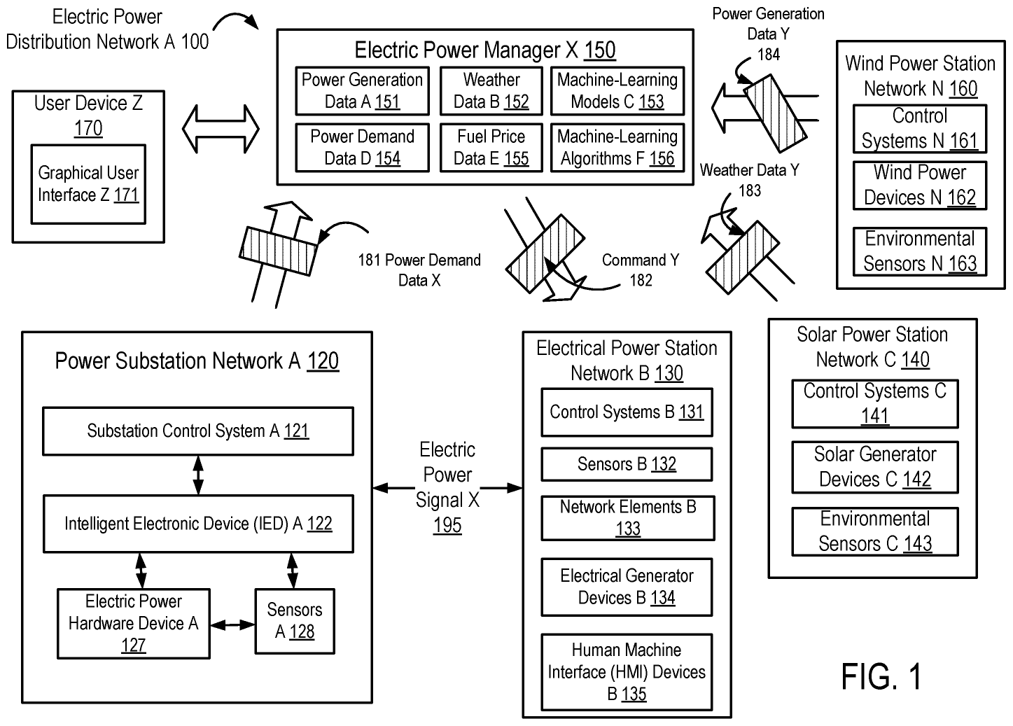

Turning to FIG. 1, FIG. 1 shows a schematic diagram in accordance with one or more embodiments. As shown in FIG. 1, an electric power distribution network (e.g., electric power distribution network A (100)) may include one or more power substation networks (e.g., power substation network A (120)), one or more electrical power station networks (e.g., electrical power station network B (130), solar power station network C (140), wind power station network N (160)), various user devices (e.g., user device Z (170)), various intelligent electronic devices (e.g., IED A (122)), various control systems (e.g., substation control system A (121), control systems B (131), control systems C (141), control systems N (161)), electric power hardware devices (e.g., electric power hardware device A (127))), various electrical generator devices (e.g., electrical generator devices B (134), solar generators C (142), wind turbines N (162)), various network elements (e.g., network elements B (133)) for operating communication paths over the electric power distribution network, and one or more electrical power managers (e.g., electrical power manager X (150)). Moreover, an electric power distribution network may refer to a communication network where different control systems, an electric power manager, and other network devices communicate using network messages. However, the electric power distribution network may also refer to power circuitry (e.g., transformers, transmission lines, etc.) for delivering electrical power (e.g., electric power signal X (195)) to various electrical loads, such as electric loads coupled to one or more power substation networks.

Furthermore, electrical generator devices may be disposed in an electrical power station network (e.g., electrical power station network B (130)) and include one or more fossil fuel power devices. Likewise, various sensors (e.g., sensors B (132)) in a power station network may collected power generation data from one or more electrical generator devices. A fossil fuel power device may include hardware and/or software that is used in a thermal power station which consumes one or more types of fossil fuel, such as coal or natural gas, to produce electricity. Moreover, fossil fuel power devices may include machinery to convert heat energy resulting from combustion into mechanical energy. The mechanical energy may subsequently operate an electrical generator device. Likewise, electrical generator devices may also include a steam turbine, a gas turbine or a reciprocating gas engine. With steam turbine power stations, fuel may be burned in a furnace causing hot gasses to flow through a boiler. In the boiler, water may be converted into steam, which may be sent through controlling valves to a turbine. Steam energy may be transferred to the turbine blades which subsequently turn a generator. Another type of fossil fuel power plant is a combined cycle power plant that may use a gas turbine in conjunction with a heat recovery steam generator (HRSG). Thus, a combined cycle power plant may combine the Brayton cycle of the gas turbine with the Rankine cycle of the HRSG. A combined cycle power plant may also use natural gas or oil as fuel. Likewise, electrical power generator devices may include standby power systems that use reciprocating internal combustion engines to serve as emergency power. For example, a standby power system may be operated in parallel with the local utility system to reduce peak power demand from electrical loads on an electrical power grid.

In some embodiments, electrical generator devices include one or more wind power devices. For example, a wind power device may be made from tubular steel with a tower that supports a wind turbine. Because wind speed may increase with height, taller towers enable wind turbines to capture more wind energy and generate more electricity for a power grid. A wind power device may further include a wind vane, one or more sensors (e.g., environmental sensors N (163)), such as anemometers, a drive train, and various blades. A wind vane may determine wind direction in order to assist in orienting the wind turbine with respect to the wind. An anemometer may determine wind speed values and transmit the wind speed data over a wind power station network accordingly. A drivetrain on a turbine may include a rotor, a main bearing, a main shaft, a gearbox, and an electrical generator. As such, a drivetrain may convert low-speed, high-torque rotation of a turbine's rotor from the blades into electrical energy. Some wind power devices may include direct-drive turbines that do not include gearboxes. More specifically, a direct-drive turbine may connect a rotor directly to an electrical generator to generate electricity. One example of a wind power device may be a horizontal-axis wind turbine that operates “upwind,” with the wind turbine pivoting to face into the wind. Another example of a wind power device is a vertical-axis wind turbine that is omnidirectional, such that the wind turbine may not require orientation adjustments. Other types of wind power devices include land-based wind turbines, offshore wind turbines, and distributed wind turbines.

In some embodiments, electrical generator devices include one or more solar generator devices. Solar power may refer to the conversion of energy from sunlight into electricity, either directly using photovoltaics (PV) or indirectly using concentrated solar energy. For example, photovoltaic cells may convert light into an electric current using the photovoltaic effect. On the other hand, a concentrating solar generator device may be a solar power tower device that use lenses or mirrors and solar tracking systems to focus a large area of sunlight to a predetermined spot. As such, the concentrated sunlight may be used to drive a steam turbine. A solar power tower device may include various heliostats that are flat, sun-tracking mirrors that focus sunlight onto a receiver at the top of a tall tower. A heat-transfer fluid heated in the receiver may be used to heat a heat-transfer fluid, such as water/steam. The heat-transfer fluid may be used in a conventional turbine generator to produce electricity. Another example of a concentrating solar generator device is a linear concentrating solar power (CSP) system that includes collectors that capture and focus the sunlight onto a linear receiver tube. Thus, linear CSP systems may also implement thermal storage. For example, the collector field may be oversized in order to heat a storage system during the day so any excess steam may be used produce electricity in the evening or during cloudy weather. In some embodiments, some power stations are hybrid power plants that use fossil fuel to supplement a renewable energy source (e.g., solar power) during periods of low energy generation (e.g., low solar energy based on seasonal weather). The hybrid power plant may include a natural gas-fired heater or gas-steam boiler/reheater is addition to the solar generators.

In some embodiments, one or more thermal energy storage devices are coupled to one or more electrical generator devices. Examples of thermal energy storages devices include a two-tank direct system, a two-tank indirect system, and single-tank thermocline systems. For example, a two-tank direct system may store fluid in two tanks, i.e., one tank stores fluid at high temperature and another other tank stores fluid at a lower temperature. Fluid from the low-temperature tank may flows through the solar collector or receiver, where solar energy heats it to a high temperature, and the heated fluid then flows to the high-temperature tank for storage. Fluid from the high-temperature tank may flow through a heat exchanger, where it generates steam for electricity production. A two-tank indirect system may function in a similar way using different fluids for heat-transfer and thermal storage. A single-tank thermocline system may store thermal energy in a solid medium (e.g., silica sand) located in a single tank. During operation, one region of the solid medium may be at high temperature, and another region may be at a low temperature. These different regions may be separated by a temperature gradient or thermocline. Thus, high-temperature heat-transfer fluid flows into the top of the thermocline and exits the bottom at a low temperature, thereby adding thermal energy to the single-tank thermocline system for storage. Likewise, reversing the fluid flow moves the thermocline upward and removes thermal energy for use in generating steam and electricity.

Turning to power circuitry, an electric power distribution network may include transmission lines that carry electricity at high voltages over predetermined distances from electrical generator devices. Likewise, transformers in an electric power distribution network may receive an alternating current (AC) electric power signal at one voltage and increase or decrease the voltage of the electric power signal. For example, a wind power station may use a step-up transformer to increase the voltage, thereby reducing the required current and power losses. When electricity reaches end-users, various transformers may reduce the voltage to make the electric power signal safe and useable by residents in the area. A power substation may link a transmission system to a distribution system that delivers electricity to end-users.

In some embodiments, an electric power distribution network includes one or more electric power managers (e.g., electric power manager X (150)). For example, an electric power manager may include hardware and/or software that is used within an electric power distribution network to manage power substations and electrical generator devices, such as renewable energy devices. For example, an electric power manager may transmit commands over the electric power distribution network in order to coordinate and/or control various control systems operating electric hardware infrastructure. In some embodiments, an electric power manager is a control server that may be a remote device coupled to one or more power substation networks (e.g., power substation network A (120)) and/or power station networks (e.g., electric power station network B (130), solar power station network C (140), wind power station network N (160)). For example, a control server may securely and centrally manage different types of IEDs deployed throughout an entire electric power distribution network. Likewise, an electric power manager may also refer to a hardware controller or a software-defined network controller operating on one or more network elements that includes functionality to administer devices within a portion of an electric power distribution network.

Turning to IEDs, an IED may be a device connected to a power substation network or power station network that includes one or more computer processors, one or more communication interfaces, and one or more memories. Moreover, the IED may be coupled to one or more electric generator devices and one or more sensors (e.g., sensors A (128)) for monitoring electrical loads and/or electrical production. In some embodiments, an IED includes hardware and/or software with functionality for performing one or more control functions, such as receiving or transmitting data over an electrical distribution network. For example, an IED may include hardware and/or software with functionality for performing electrical protection functions, collecting local control intelligence with respect to electric power hardware, and/or monitoring various processes performed with equipment. Likewise, an IED may include a communication interface for communicating directly with one or more control systems or other network devices, such as a master node in a SCADA system. In some embodiments, IED data are transmitted over an electric power distribution network. For example, IED data may include operational and non-operational data relating to various functions performed by one or more IEDs. Operational data may include data that describes instantaneous values of power system analog and status points such as volts, amps, watts, a circuit breaker's status, switch positions. An example of operational data may include data for a supervisory control and data acquisition (SCADA) system. As such, operational data may also include control data that is time critical and used to monitor and control an electric power system (e.g., by opening circuit breakers, changing tap settings, indicating equipment failures). On the other hand, non-operational data may include data files and waveforms such as event summaries, oscillographic event reports, status points, and analog points that have a logical state or a numerical value. Non-operational data may be used for predictive analytics or monitoring the long-term health of a substation or electric power transmission distribution system.

Turning to power substation networks, a power substation network may include one or more control systems (e.g., substation control system A (121)). For example, a substation control system may be a data concentrator that may include hardware and/or software for polling IEDs and other devices for analog values and status changes at various data collection rates. In some embodiments, a substation control system may include functionality for acting as a gateway towards one or more control servers, such as an electric power manager. Likewise, various power substation networks may use various communication protocols, such as IEEE 802.3 for Ethernet communications. Further, various substation automation applications may operate on a power substation network. For example, multiple communication paths may transmit power demand data between IEDs and a control server. In some embodiments, communication paths transmit through a SCADA system as well as other external devices, such as a data warehouse.

Keeping with electric power distribution networks, IEDs may support various communication protocols to transmit and/or receive IED data, control data, power demand data, power generation data, and other data over a communication network. In particular, an IED may use communication protocols based on one or more standards promulgated by the International Electrotechnical Commission (IEC), such as the IEC61850 standard for substation automation. For example, IEC61850 may provide a protocol suite for interoperability and advanced communications capabilities among various IEDs. Another communication protocol is Distributed Network Protocol (DNP) 3.0, which is a communications protocol used in SCADA systems and remote monitoring systems. Likewise, the communication protocols may also include IEC 60870 part 5 (also called “IEC104”), which may be used for telecontrol in electrical engineering and power system automation applications.

Returning to control systems, control systems may include a programmable logic controller (PLC), a distributed control system (DCS), a supervisory control and data acquisition (SCADA), and/or a remote terminal unit (RTU). For example, a programmable logic controller may control valve states, fluid levels, pipe pressures, warning alarms, and/or pressure releases throughout a power-generation facility. In particular, a programmable logic controller may be a ruggedized computer system with functionality to withstand vibrations, extreme temperatures, wet conditions, and/or dusty conditions, for example, around a refinery. A distributed control system may be a computer system for managing various processes at various facilities using multiple control loops. As such, a distributed control system may include various autonomous controllers (such as remote terminal units) positioned at different locations throughout the facility to manage operations and monitor processes. Likewise, a distributed control system may include no single centralized computer for managing control loops and other operations. On the other hand, a SCADA system may include a control system that includes functionality for enabling monitoring and issuing of process commands through local control at a facility as well as remote control outside the facility. With respect to an RTU, an RTU may include hardware and/or software, such as a microprocessor, that connects sensors and/or actuators using network connections to perform various processes in the automation system. Likewise, a control system may be coupled to one or more IEDs or electrical generator devices.

In some embodiments, a SCADA system includes a master node. For example, an electric power manager may be a master node that provides acquired power demand data, power generation data, control data, and various recommendations to a human operator for performing remote control tasks. The master node may server as a central monitoring station that may present real-time data to a human user for optimizing electric power operations. In some embodiments, an electric power manager is the master node in a SCADA system.

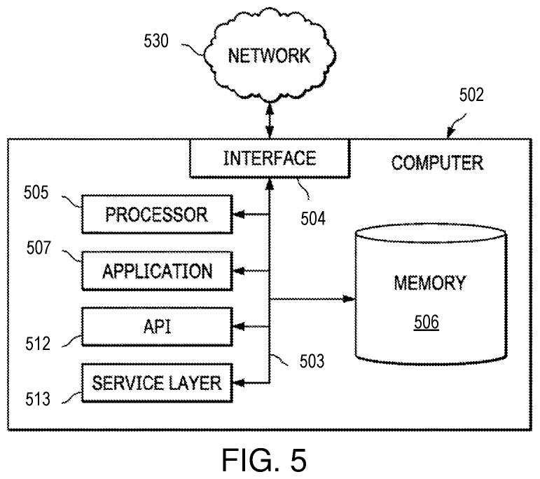

Furthermore, network elements may include switches, routers, hubs, cross connections, repeaters, active network components, and/or passive network components. In particular, a network element may be an addressable set of equipment that forms a portion of a communications path and serves a section, line or path terminating function. Moreover, the electric power distribution network A (100) may be similar to network (530) described below in FIG. 5 and the accompanying description. User devices may include personal computers, handheld computer devices such as a smartphone or personal digital assistant, or a human machine interface (HMI) device (e.g., one of HMI devices B (135)). Electric power hardware devices may include power system equipment, such as power transformers, circuit breakers, recloser controls, capacitor banks, and electronic multifunction meters. In some embodiments, user devices, IEDs, network controllers, network elements, electric power managers, and/or control systems include computer systems similar to computer system (502) shown in FIG. 5 and the accompanying description.

In some embodiments, a user device (e.g., user device Z (170)) may communicate with an electric power manager to manage electric-power generation and/or electric power distribution over an electric power distribution network. For example, a user may interact with a user interface (e.g., graphical user interface Z (171)) to change thresholds and parameters for electrical generator devices and other hardware devices, e.g., to achieve electric power optimization. Through user selections or automation, an electric power manager may provide various reports for information in a graphical user interface regarding predicted electricity production, predicted electricity demand, status updates on electric power stations and power substations, and the like.

In some embodiments, an electric power manager (e.g., electric power manager X (150) may include hardware and/or software with functionality for generating and/or updating one or more machine-learning models (e.g., machine-learning models C (153)) for use in analyzing electrical power demand and/or electric power generation. For example, an electric power manager may store power generation data (e.g., power generation data A (151), power generation data Y (184)), weather data (e.g., weather data B (152), weather data Y (183)), power demand data (e.g., power demand data D (154), power demand data X (181)), fuel price data (e.g., fuel price data E (155)), and/or other types of data to generate and/or update one or more machine-learning models. In particular, one or more power station networks and power substation networks may include various sensor to collect data (e.g., sensors A (128), sensors B (132), environmental sensors C (143), environmental sensors N (163)). Power generation data may describe the power capabilities of one or more electrical generator devices, such as ramping data associated with ramping rates or ramping capacity, power reserve data such as available reserve power, status updates (e.g., whether an electrical generator device is offline or online), transmission line capacity, and the like. Weather data may include data that describes whether for a predetermined region, such as around a power plant, such as wind data, temperature data, humidity data, pressure data, and sunlight data. Power demand data may describe various electrical loads on an electric power distribution network, such as the power capacity needed to supply a worst-case combination of electrical loads. Likewise, power demand data may also describe various type of loads, such as resistive loads, capacitive loads, and inductive loads. Fuel price data may describe the cost of various fuel sources, such as coal, oil, and natural gas for operating one or more electrical generator devices.

Furthermore, different types of machine-learning models may be trained, such as convolutional neural networks, U-Net models, deep neural networks, recurrent neural networks, inductive learning models, deductive learning models, supervised learning models, unsupervised learning models, reinforcement learning models, etc. In some embodiments, two or more different types of machine-learning models are integrated into a single machine-learning architecture, e.g., a machine-learning model may include different types of neural networks. In some embodiments, an electric power manager generates augmented or synthetic data to produce a large amount of interpreted data for training a particular model.

With respect to artificial neural networks, for example, a neural network may include one or more hidden layers, where a hidden layer includes one or more neurons. A neuron may be a modelling node or object that is loosely patterned on a neuron of the human brain. In particular, a neuron may combine data inputs with a set of coefficients, i.e., a set of network weights for adjusting the data inputs. These network weights may amplify or reduce the value of a particular data input, thereby assigning an amount of significance to various data inputs for a task being modeled. Through machine learning, a neural network may determine which data inputs should receive greater priority in determining one or more specified outputs of the neural network. Likewise, these weighted data inputs may be summed such that this sum is communicated through a neuron's activation function to other hidden layers within the neural network. As such, the activation function may determine whether and to what extent an output of a neuron progresses to other neurons where the output may be weighted again for use as an input to the next hidden layer.

Turning to convolutional neural networks, a convolutional neural network (CNN) is a type of artificial neural network that may be used in computer vision and image recognition, e.g., for processing pixel data. For example, a convolutional neural network may include functionality for performing an application of a filter to an input (e.g., an input image) that results in a particular activation, where repeated filter application may result in an output map of activations called a feature map. A feature map may indicate the locations and strength of one or more detected features in the input to the convolutional neural network. Thus, a convolutional neural network may have the ability to automatically learn multiple filters in parallel specific to a training dataset under the constraints of a specific predictive modeling problem, such as image classification.

In some embodiments, an electric power manager uses one or more ensemble learning methods in connection with multiple machine-learning models. For example, an ensemble learning method may use multiple types of machine-learning models to obtain better predictive performance than available with a single machine-learning model. In some embodiments, for example, an ensemble architecture may combine multiple base models to produce a single machine-learning model. One example of an ensemble learning method is a BAGGing model (i.e., BAGGing refers to a model that performs Bootstrapping and Aggregation operations) that combines predictions from multiple neural networks to add a bias that reduces variance of a single trained neural network model. Another ensemble learning method includes a stacking method, which may involve fitting many different model types on the same data and using another machine-learning model to combine various predictions. In some embodiments, two or more different types of machine-learning models are integrated into a single machine-learning architecture, e.g., a machine-learning model may include different types of neural networks.

In some embodiments, various types of machine-learning algorithms (e.g., machine-learning algorithm (156)) may be used to train the model, such as a backpropagation algorithm. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on an error function (also called a “loss function”). The error function may be based on various criteria, such as mean squared error function, a similarity function, etc., where the error function may be used as a feedback mechanism for tuning weights in the machine-learning model.

In some embodiments, a machine-learning model is trained using multiple epochs. For example, an epoch may be an iteration of a model through a portion or all of a training dataset. As such, a single machine-learning epoch may correspond to a specific batch of training data, where the training data is divided into multiple batches for multiple epochs. Thus, a machine-learning model may be trained iteratively using epochs until the model achieves a predetermined criterion, such as predetermined level of prediction accuracy, a minimized mismatch between predicted and observed data, and/or training over a specific number of machine-learning epochs or iterations. Thus, better training of a model may lead to better predictions by a trained model.

Turning to recurrent neural networks, a recurrent neural network (RNN) may perform a particular task repeatedly for multiple data elements in an input sequence, with the output of the recurrent neural network being dependent on past computations. As such, a recurrent neural network may operate with a memory or hidden cell state, which provides information for use by the current cell computation with respect to the current data input. For example, a recurrent neural network may resemble a chain-like structure of RNN cells, where different types of recurrent neural networks may have different types of repeating RNN cells. Likewise, the input sequence may be time-series data, where hidden cell states may have different values at different time steps during a prediction or training operation. For example, where a deep neural network may use different parameters at each hidden layer, a recurrent neural network may have common parameters in an RNN cell, which may be performed across multiple time steps. To train a recurrent neural network, a supervised learning algorithm such as a backpropagation algorithm may also be used. In some embodiments, the backpropagation algorithm is a backpropagation through time (BPTT) algorithm. Likewise, a BPTT algorithm may determine gradients to update various hidden layers and neurons within a recurrent neural network in a similar manner as used to train various deep neural networks. In some embodiments, a recurrent neural network is trained using a reinforcement learning algorithm such as a deep reinforcement learning algorithm. For more information on reinforcement learning algorithms, see the discussion below.

Embodiments are contemplated with different types of RNNs. For example, classic RNNs, long short-term memory (LSTM) networks, a gated recurrent unit (GRU), a stacked LSTM that includes multiple hidden LSTM layers (i.e., each LSTM layer includes multiple RNN cells), recurrent neural networks with attention (i.e., the machine-learning model may focus attention on specific elements in an input sequence), bidirectional recurrent neural networks (e.g., a machine-learning model that may be trained in both time directions simultaneously, with separate hidden layers, such as forward layers and backward layers), as well as multidimensional LSTM networks, graph recurrent neural networks, grid recurrent neural networks, etc. With regard to LSTM networks, an LSTM cell may include various output lines that carry vectors of information, e.g., from the output of one LSTM cell to the input of another LSTM cell. Thus, an LSTM cell may include multiple hidden layers as well as various pointwise operation units that perform computations such as vector addition.

In some embodiments, a transformer neural network (hereinafter “transformer model”) is used to determine predicted data and/or actions for an electric power agent. A transformer model may be based on a sequence-to-sequence (Seq2Seq) architecture that transforms a given sequence of elements (e.g., a sequence of words in a sentence) into another sequence. For example, a Seq2Seq model may include an encoder and a decoder, where the encoder obtains the input sequence and maps the input sequence into a higher dimensional space. An abstract vector in the higher dimensional space may be provided to the decoder to produce a predicted output sequence. In particular, a transformer may include an attention-mechanism that analyzes a portion of an input sequence and determines at a particular step which other parts of the input sequence are relevant. As such, an attention-mechanism may determine a predicted output based on several other relevant inputs at the same time and attribute different weights to the other relevant inputs. Thus, a decoder may take as an input the encoded input sequence from an encoder and the weights provided by the attention-mechanism. In other words, transformer models may use a self-attention (intra-attention) mechanism that eliminates recurrent operations and is thus repurposed to determine the latent space representation of both the encoder and the decoder sides. With the absence of recurrence, positional-encoding may be added to the input and output embeddings of a transformer model. The positional information may thereby provide the transformer model with the order of input and output sequences.

Keeping with transformer models, a transformer model may pass an input sequence parallelly so that various parallel processors (e.g., processors in a graphical processing unit (GPU) can be used effectively and the speed of training can also be increased. In some embodiments, a transformer model is organized as a stack of encoder-decoder networks that works in an auto-regressive way, using a previously generated symbol as input for the next prediction. Decoders and encoders may include a multi-head self-attention layer and a position wise feed-forward network (FFN) layer. The multi-head sub-layer may use multiple attention functions, while the FFN sub-layer is a fully connected network used to process the attention sublayers. For example, an FFN sub-layer may apply two linear transformations on each position and a ReLU activation function.

Turning to reinforcement learning, the electric power manager may perform one or more reinforcement learning algorithms using a reinforcement learning system (e.g., reinforcement learning system X (210)). In particular, a reinforcement learning algorithm may be a type of method that autonomously learns agent policies through multiple iterations of trials and evaluations based on observation data. The objective of a reinforcement learning algorithm may be to learn an agent policy x that maps one or more states of an environment to an action so as to maximize an expected reward J(π). A value reward may describe one or more qualities of particular state, agent action, and/or trajectory at particular time within an operation, such as an electric power generation operation. As such, a reinforcement learning system may include hardware and/or software with functionality for implementing one or more reinforcement learning algorithms. For example, a reinforcement learning system may include an action selector engine (e.g., action selector engine A (220)) to determine commands and/or electric power actions based on policy data (e.g., policy data A (231)) and one or more reward functions (e.g., reward functions (223)). More specifically, a reinforcement learning algorithm may train a policy to make a sequence of decisions based on the observed states of the environment to maximize the cumulative reward determined by a reward function. For example, a reinforcement learning algorithm may employ a trial-and-error procedure to determine one or more agent policies based on various agent interactions with a complex environment, such as an electric power generation environment that includes multiple electrical loads and multiple electrical generator devices. As such, a reinforcement learning algorithm may include a reward function that teaches a particular action selection engine to follow certain rules, while still allowing the reinforcement learning model to retain information learned from weather data, power generation data, power demand data, fuel price data, and environmental data.

In some embodiments, one or more components in a reinforcement learning system are trained using a training system (e.g., training system (230)). For example, an agent policy and/or a reward function may be updated through a training process that is performed by a machine-learning algorithm. In some embodiments, historical data (e.g., historical observation data A (241)), augmented data (e.g., augmented observation data B (242)), and/or synthetic data (e.g., synthetic observation data C (243)) may provide a supervised signal for training an action selector engine, an agent policy, and/or a reward function, such as through an imitation learning algorithm. In another embodiment, an interactive expert may provide data for adjusting agent policies and/or reward functions.

Turning to deep reinforcement learning, deep reinforcement learning may combine various machine-learning models (e.g., artificial neural networks) with a framework of reinforcement learning that helps agents learn how to reach their goals. That is, deep reinforcement learning may use both function approximation and target optimization in order to map various states and actions to specific rewards. For example, artificial neural networks as used in computer vision, natural language processing, and time series predictions may be combined with reinforcement learning algorithms.

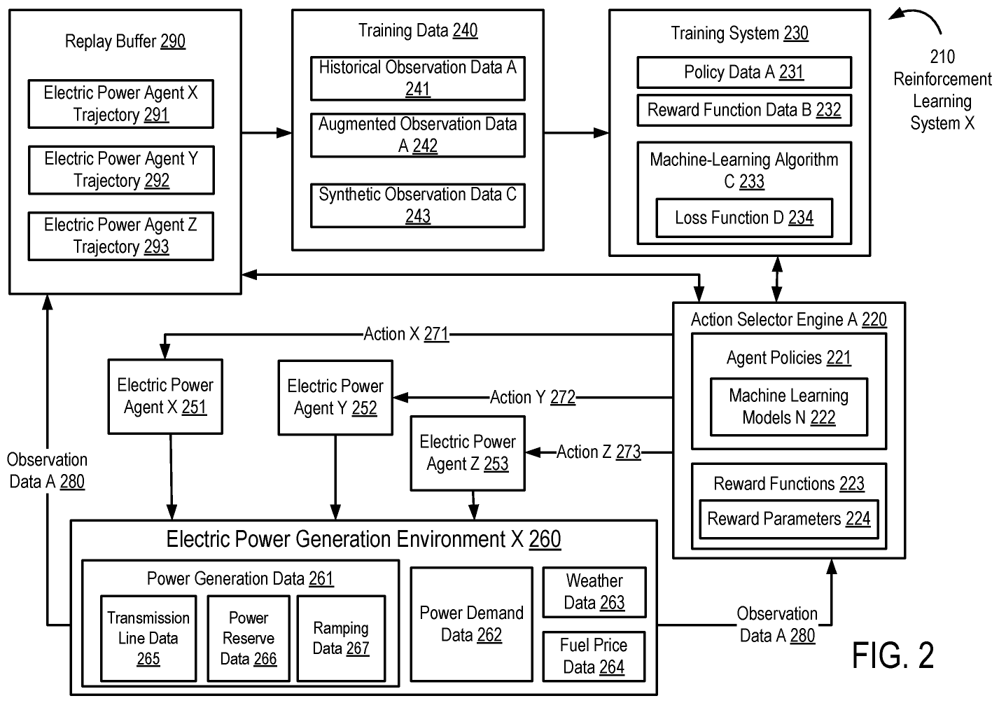

Turning to FIG. 2, FIG. 2 illustrates a reinforcement learning system in accordance with one or more embodiments. As shown in FIG. 2, a reinforcement learning system (e.g., reinforcement learning system X (210)) may include one or more electric power agents (e.g., electric power agent X (251), electric power agent Y (252), electric power agent Z (253)) that include hardware and/or software to perform one or more actions (e.g., action X (271), action Y (272), action Z (273)). In some embodiments, for example, an electric power agent may correspond to a control system, such as control systems (121, 131, 141, 161) in FIG. 1 and the accompanying description, or an electrical generator device (e.g., one of the electrical generator devices B (134), one of the solar generator devices C (142), one of the wind power devices N (162)). Likewise, in some embodiments, electric power agents merely correspond to an electric power manager's control of an electric power generation operation as distributed among multiple electric power systems. As such, the actions (271, 272, 273) may correspond to commands by an electric power manager or specific electrical generation operations implemented by various controllers in an electric power distribution network.

Keeping with FIG. 2, reinforcement learning algorithms may determine actions based on an agent's interaction with a particular environment. In other words, an environment may define one or more states resulting from these actions, and which may be described as a Markov Decision Process (MDP). Thus, a particular environment may have an S set of states, an A set of actions, where a P(s'|s,a) transition model may describe a probability that an action a in the state s leads to state s′ and an R(s,a) reward function. An agent may perform different actions with this environment based on the agent's policy x. With respect to the context of electric power generation operations, various actions performed by electric power agents may result in changes to one or more states of a electric power generation environment. For example, an electric power generation environment (e.g., electric power generation environment X (260)) may be multiple power plants, such as fossil fuel power stations and/or renewable energy power stations (e.g., wind turbine power stations and/or solar power stations). In particular, the electric power generation environment may be described using various data, such as power generation data (261) that includes transmission line data (265), power reserve data (266), and ramping data (267), power demand data (262), weather data (263), and fuel price data (264). Some examples of actions based on various states in the electric power generation environment may include turning on or off various electric power generation devices, as well as regulating the amount of electricity produced over a predetermined time interval to manage electrical loads.

In some embodiments, a reinforcement learning system includes an action selector engine (e.g., action selector engine A (220)). In particular, an action selector engine may include hardware and/or software with functionality for determining one or more actions based on one or more agent policies (e.g., agent policies (221)) and observation data (e.g., observation data A (280)) characterizing one or more current states of an electric power generation environment. Some examples of an action selector engine may include machine-learning models, such as an artificial neural network, which determines actions based on various input features within the observation data. Depending on changes to the observation data, an electric power agent may be instructed to implement a particular action, e.g., by a command or control signal. In another embodiment, the action selector engine determines actual commands for components in a power station network (e.g., an action may correspond to command Y (182) that is adjusting one or more settings in electric power station network B (130) in FIG. 1). In another embodiment, an action selector engine determines action scores that are used by electric power agents for adjusting electric power operations, where different action scores correspond to different power generation settings.

Turning to observation data, observation data may include power generation data, power demand data, fuel cost data, weather data, and other environmental data, such as wind data, sunlight data, and temperature data. Observation data at a particular time step may include data from a previous time step that may be beneficial in characterizing an electric power generation environment. In some embodiments, a reinforcement learning system may include a replay buffer (e.g., replay buffer (290)) that stores observation data in association with different electric power agent trajectories (e.g., electric power agent X trajectory (291), electric power agent Y trajectory (292), electric power agent Z trajectory (293)). For example, a trajectory may specify a sequence of observations characterizing respective states of a particular environment. In some embodiments, a trajectory may correspond to a vector of different states of an electric power generation environment, different actions performed by various electric power agents, and/or various reward values obtained in response to the different actions.

In some embodiments, a reinforcement learning system uses one or more pure reinforcement learning algorithms (e.g., without an experts' demonstration or deep learning) to determine an agent policy for one or more agents. A pure reinforcement learning algorithm may start with a random policy that is continuously improved through trial-and-error based on various rewards received using a reward function. For example, a policy may be trained using a software simulator for an electric power generation environment. The resulting simulation-trained policy may provide a starting point in a real power generation operation to further improve the policy.

In some embodiments, a reinforcement learning system includes a training system (e.g., training system (230)). The training system may be coupled to an action selector engine and include hardware and/or software with functionality for updating one or more policy parameters in a respective agent policy (e.g., policy parameters (222)) and/or one or more reward parameters (e.g., reward parameters (224)) in a respective reward function (e.g., reward function data B (232)). In particular, a training system may use training data (e.g., training data (240)) to iteratively update agent policies and/or reward functions using one or more machine-learning algorithms (e.g., machine-learning algorithm C (233)). Here, training data may include an expert's demonstrations or trajectories that may be obtained by enabling a human to control an electric power agent's actions, and logging the resulting expert observations of an electric power generation environment. Expert demonstrations may also correspond to historical data (e.g., historical observation data A (241)), augmented data (e.g., augmented observation data B (242)), and/or synthetic data (e.g., synthetic observation data C (243)) that provides an optimized action with respect to a particular state of an electric power generation environment. Thus, a training system may use a loss function (e.g., loss function D (234)) or a cost function to determine a difference between an expert's demonstration and selected actions based on one or more agent policies. The training system may use this difference to update parameters within a reinforcement learning system through one or more imitation learning processes.

With respect to imitation learning processes, a reinforcement learning system may use imitation learning processes to learn an optimal agent policy or optimal reward function from an expert's demonstration or a supervising signal. Such techniques may be distinguished from pure reinforcement learning algorithms that learn from sparse rewards or through manually specifying a reward function. In other words, a reinforcement learning system may have an easier avenue to learn an optimal agent policy or actual reward function by having a teacher demonstrate a desired behavior rather than manually engineering such behavior. Accordingly, an expert's demonstrations may form a trajectory τ=(s₀, a₀, s₁, a₁, . . . ), where the expert's actions are determined by an expert's policy, that may correspond to an optimal policy.

In one embodiment, an imitation learning process is a behavioral cloning process. For example, a reinforcement learning system may use behavior cloning to directly map from one or more states to one or more actions, thereby forming a state-action pair. Based on an expert's demonstrations, these state-action pairs may be determined using supervised learning and a loss function. An electric power generation environment with an identifiable set of states may be well suited for a behavioral cloning process.

In another embodiment, an imitation learning process is a direct policy learning (DPL) process or direct policy searching process that uses training data to determine an agent policy that maximizes an expected reward and/or reduces an expected loss. In particular, a DPL process may iteratively access an interactive expert during a training process. With sufficient training data, an electric power agent may remember past mistakes and train the agent policy in order to converge at an optimum policy. For example, a DPL process may implement a data aggregation algorithm or policy aggregation algorithm. In a data aggregation algorithm, the data aggregation algorithm may train the agent policy using an entire training dataset. In a policy aggregation algorithm, the policy aggregation algorithm trains an agent policy on the training data obtained in the previous iteration and subsequently combines the current policy with previous policies using geometric blending.

In another embodiment, an imitation learning process is an inverse reinforcement learning (IRL) process. For example, an IRL process may determine a reward function of the electric power generation environment based on an expert's demonstrations. After determining the actual reward function, the IRL process may determine the optimal policy that maximizes the identified reward function using reinforcement learning. In particular, the reward function may be parameterized (e.g., reward parameters (224)) and the reward parameters may be iteratively updated. After identifying both the reward function and an optimal policy, the optimal policy may be compared to an identified expert's policy.

Keeping with IRL processes, an IRL process method may be a model-based algorithm or a model-free algorithm. In a model-based algorithm, the reinforcement learning system may determine a linear reward function or a forward model of a electric power generation environment that is used to learn an agent's policy. In a model-free algorithm, the reward function may be complex and thus a machine-learning model (e.g., a neural network) may be used to approximate the complex reward function.

While FIGS. 1 and 2 show various configurations of components, other configurations may be used without departing from the scope of the disclosure. For example, various components in FIGS. 1 and 2 may be combined to create a single component. As another example, the functionality performed by a single component may be performed by two or more components.

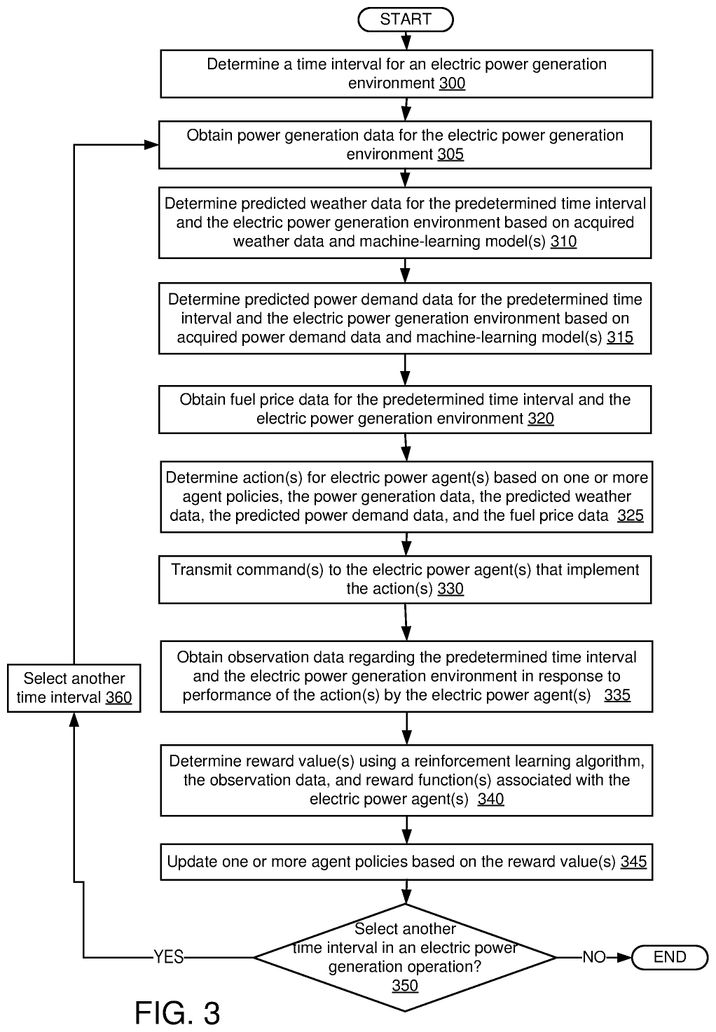

Turning to FIG. 3, FIG. 3 shows a flowchart in accordance with one or more embodiments. Specifically, FIG. 3 describes a general method for managing electric power agents in an electric power distribution network using reinforcement learning. One or more blocks in FIG. 3 may be performed by one or more components (e.g., electric power manager X (150)) as described in FIGS. 1 and 2. While the various blocks in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 300, a time interval is determined for an electric power generation environment in accordance with one or more embodiments. In particular, the electric power generation environment may include various electric power station networks that include fossil fuel power plants and/or renewable energy power sources, such as solar generator devices and wind power devices. The electric power generation environment may also include electric power infrastructure for transmitting electricity to various electrical loads coupled to an electric power distribution network, such as end-users and electric power hardware devices. In some embodiments, a time interval includes a particular time step and a specific time horizon that is achieved using multiple time steps. Thus, an electric power agent may perform actions based on one or more agent policies at each time step until the time horizon is reached.

In some embodiments, an electric power manager automatically selects a particular time period for performing one or more electric power generation operations. Likewise, a user device may receive a selection of a particular time interval from a user. Moreover, time intervals may correspond to an hour, a 24-hour period, a week, a month, a year, or another predetermined time period for controlling electric power generation in an electric power distribution network. In some embodiments, an electric power distribution network is managed in real-time, where the time interval is a periodic interval for updating electric power distribution in the network.

In Block 305, power generation data is obtained for an electric power generation environment in accordance with one or more embodiments. For example, power generation data may describe various constraints for distributing electricity, such as power balance data, transmission line capabilities, and/or the capabilities of various electrical generator devices. As such, power generation data may identify the amount of power currently or previously generated over a past time interval by a solar power station, a wind turbine station, etc. In some embodiments, power generation data is collected by various sensors and/or IEDs in power substations and/or power stations. On the other hand, power generation data may also be static data based on infrastructure used by an electric power distribution network. For example, transmission line specifications may correspond to hardware specifications based on the type and dimensions of the transmission lines that are used to transport electricity from electrical generator devices to various electrical loads.

In Block 310, predicted weather data is determined for a predetermined time interval and electric power generation environment based on acquired weather data and one or more machine-learning models in accordance with one or more embodiments. For example, an electric power manager may determine predicted weather data for the selected time interval from Block 300 in order to determine various states of the electric power generation environment. Where the predetermined time interval is a particular day, the predicted weather data may describe possible weather over the given day.

In some embodiments, for example, acquired weather data is input to a machine-learning model, such as an artificial neural network, to determine predicted weather data for a predetermined region at the current time interval. The acquired weather data may correspond to weather data from one or more previous time intervals, as well as other data sources, such as weather forecasts for a particular area. In particular, the predicted weather data may describe the weather around one or more electric power stations, such as the amount of sunlight expected for a solar power station or the amount of wind for wind turbines. If the acquired weather data is a radar image, for example, a convolution neural network may be used to identify an amount of cloud coverage for a solar power station. On the other hand, a recurrent neural network may be used to determine changes in wind velocities based on environmental sensor data.

Turning to acquired weather data, weather data and other environmental data may be acquired from various sensors disposed in the vicinity of one or more renewable power stations (e.g., wind turbines devices or solar power devices). For example, weather data may be collected from environmental sensors, such as temperature sensors, wind sensors, sunlight sensors, humidity sensors, and other types of sensors. Likewise, weather data may also be collected from secondary sources, such as downloading weather reports and radar images from remote servers.

Wind sensors may determine wind speed data and/or wind direction data. For example, a wind sensor may include an anemometer, where some types of anemometers include vane anemometers, thermal anemometers, thermal anemometers with velocity/temperature profiling, cup anemometers, constant-temperature anemometers, and constant-power anemometers. For illustration, a cup anemometer cup may determine the wind velocity in a plane perpendicular to the axis of its rotation cups. The cup anemometer may also be mounted with the shaft perpendicular to a horizontal plane in order to measure a wind component that is parallel to the ground. Likewise, a thermal (or “hot wire”) anemometer may determine a velocity of a flowing fluid based on an amount of heat removed from a heated temperature sensor by the flowing fluid. A thermal anemometer may use a second, unheated temperature sensor to compensate for variations in the air temperature. Thermal anemometers may include single point instruments or multi-point arrays.

In some embodiments, for example, a sunlight sensor is a solarimeter that includes hardware for measuring the flow of solar radiation. A solarimeter may uses the photovoltaic effect to measure the amount of solar radiation reaching a given surface on the solarimeter. A solarimeter may be a chemical solarimeter that uses a solution that measures radiation from absorbed light in a process known as quantum yield identification. Another example of a solarimeter is a physical solarimeter that may include a bolometer, one or more photodiodes, and/or a thermopile. A bolometer may include a heat sink that identifies changes in temperature, while a photodiode may identify an amount of light energy based on a generated electrical current. Likewise, thermopiles may convert heat into electrical current, which can also be used to determine one or more radiation levels.

In Block 315, predicted power demand data for a predetermined time interval and an electric power generation environment based on acquired power demand data and one or more machine-learning models in accordance with one or more embodiments. In some embodiments, an electric power manager determines predicted power demand data for the selected time interval from Block 300. Similar to the predicted weather data from Block 310, the predicted power demand data may also be used to determine various states of the electric power generation environment over the selected time interval. Where the predetermined time interval is a particular day, for example, the predicted power demand data may describe possible electric loads on an electric power distribution network over the given day.

Similar to Block 310, acquired power demand data may be collected from one or more previous time intervals for an electric power distribution network. For example, various IEDs may collect sensor data from various electrical loads regarding power consumption for use in predicting future power demands on the electric power distribution network. Likewise, the acquired power demand data may also be obtained from data sources outside the electric power distribution network, such as population data regarding end-users being serviced by respective power substations. Power demand data may also be predicted using weather data, as changes in weather may directly affect user power demands. Using the historical power demand data, one or more machine-learning models may be used to predict an amount of electrical power required to satisfy various electrical loads on the electric power distribution network.

In Block 320, fuel price data are obtained for a predetermined time interval and an electric power generation environment in accordance with one or more embodiments. For example, fuel price data may be collected in real-time from various data sources, such as remote servers that provide cost information. In some embodiments, fuel price data is predicted using one or more machine-learning models. More specifically, fuel price data may be predicted based past fuel price data, weather data, and other input data, such as business data relating to economic growth and recessions.

In Block 325, one or more actions are determined for one or more electric power agents based on one or more agent policies, power generation data, predicted weather data, predicted power demand data, and/or fuel price data in accordance with one or more embodiments. For example, an electric power manager may include an action selector engine for performing agent-based dispatch for one or more electric power agents. For example, an agent policy for a respective electric power agent may dynamically learning an optical action for one or more environment states and system constraints. In some embodiments, an agent policy based on one or more reward policies. For example, a particular reward function may correspond to a total generation cost of supplying electricity over a predefined time interval. Likewise, whether a particular action is the optimum action may be based on the total generation cost in view of the corresponding power consumption during the respective time interval. The system constraints may include electrical supply and demand, transmission lines capability, and generators ramping capability.

Furthermore, agent policies may undergo continuous interaction between the electric power agents and the electric power generation environment at each time interval. At the beginning of a time interval, an electric power agent or an electric power manager may sense the environment's status through various states (e.g., system constraints, environmental states such as weather, the demands of various electrical loads, etc.). Based on the current states in the environment, an electric power agent or an electric power manager may decide on an action that may lead to the least cost for sufficient electricity generation from that time step. For example, the selected action may last from the time step until the end of a particular time period, such as an operational year.

In some embodiments, an agent policy may be trained using historical observation data where rule-based algorithms were previously used to control electricity production rates. One technique for training the agent policy may include using previous weather data, power demand data, power generation data, and/or fuel price data to assign positive rewards upon attaining optimal total cost values. Thus, the agent policy may be trained to recommend various electric power adjustments to a user device in order to achieve a desired cost objectives and/or other objectives (e.g., lower carbon emissions). The agents may learn and improve through increasing numbers of electric power generation operations.

In Block 330, one or more commands are transmitted to one or more electric power agents that implement one or more actions in accordance with one or more embodiments. For example, commands may be network messages or control signals that correspond to one or more actions performed by one or more electric power agents. Likewise, the commands may implement the one or more actions determined in Block 325. In some embodiments, an electric power manager transmits a command to a control system coupled to an electrical generator device, where the control system is the electric power agent that implements the respective action.

In Block 335, observation data are obtained regarding a predetermined time interval and an electric power generation environment in response to performance of one or more actions by one or more electric power agents in accordance with one or more embodiments. For example, the observation data may include acquired weather data, acquired power consumption data, power generation data, fuel cost data, and other data relating to one or more states of the electric power generation environment. Additionally, observation data may be collected for the selected time interval from Block 300, such as for determining actions for various time steps within the selected time interval.

In Block 340, one or more reward values are determined using a reinforcement learning algorithm, observation data, and one or more reward functions associated with one or more electric power agents in accordance with one or more embodiments. For example, a reward value may be determined for an electric power agent at the beginning of a particular time interval that represents the electric generation cost during the previous time interval. Thus, the reward value may be used to evaluate the effectiveness of a particular action at one or more environment states.

In some embodiments, a time interval is denoted by t in a reinforcement learning algorithm, while a dispatching horizon for an action may be denoted by T. The environment and agent interaction may occur at each time interval along the horizon, i.e., t=0, 1, 2, . . . , T. In some embodiments, the cumulative production cost C during the dispatching horizon T is expressed using the following equation:

$$C = {\sum }_{k = 0}^{T - 1} {γ}^{k} {r}_{t + k + 1} \qquad Equation 1$$

where γ∈[0,1] is a constant to determine how farsighted a dispatching agent is when determining actions and r is the single-step cost. An electric power agent's objective may be to minimize one or more cost functions accordingly based on various security constraints through an iterative learning process. In some embodiments, a reward function corresponds to a particular cost function for determining a reward value, which is expressed using the following equation:

$${Q}^{π} ( s , a ) = 𝔼 [ C \vert s = {s}_{t} , a = {a}_{t} ] \qquad Equation 2$$

where Q^{π} (s, a) corresponds to a state-action value function, s corresponds to a state from the time interval t until the end of a horizon T, a corresponds to an action dispatched by an electric power agent based on the environment's status, and π corresponds to the electric power agent's policy. A cost function or reward function may govern the expected (or average) total production cost from the time interval to the horizon's end. As such, a deep reinforcement learning algorithm may determine the function Q^{π} (s, a), and thus one or more agent policies for one or more electric power agents. In some embodiments, an agent policy is determined using deep reinforcement learning using the following equation:

$${Q}^{π} ( s , a ; θ ) \qquad Equation 3$$

where θ corresponds to a parameter vector of a deep neural network that estimate the value function governing various weights and biases. Moreover, a deep reinforcement learning algorithm may estimate the cost-optimal dispatch signal (i.e., an agent policy) for determining various actions. In some embodiments, an agent policy is expressed using the following equation:

$$π ( s ; ϑ ) \qquad Equation 4$$

where ∂ represents a parameter vector of a deep neural network governing the weights and biases of the agent policy.

In Block 345, an agent policy is updated based on a reward value in accordance with one or more embodiments. In particular, the reward value may correspond to the reward value determined in Block 340. For example, a reinforcement learning process may be governed by dependent and iterative updates of the reward value and agent policies. In particular, an agent policy based on Equation 4 may have updated to one or more deep neural networks' parameters under any actor-critic deep reinforcement learning (DRL) scheme. Thus, objective may be to have an accurate estimate of Q^{π} (s, a), which may result in a determination of a cost-optimal agent policy π (s; ∂) over a time horizon T.

Furthermore, a reinforcement learning system may adjust an agent's policy based on various rewards obtained by previous actions for different time intervals and different time horizons. In some embodiments, an agent policy is updated using a training system. In particular, one or more imitation learning techniques may be used to learn and/or adjust an agent policy or a reward function based on training data. For example, a mismatch between observation data and training data may be obtained using a cost function. Accordingly, policy parameters or reward parameters may be adjusted based on error data associated with the mismatch.

In Block 350, a determination is made whether to select another time interval in an electric power generation operation in accordance with one or more embodiments. Where electric power generation is complete, this process may end. Where one or more electric power generation operations remain for an electric power distribution network, the process may proceed to Block 360 to determine one or more actions for one or more electric power agents according to an updated agent policy.

In Block 360, another time interval is selected in accordance with one or more embodiments. Similar to Block 300, the next time interval may correspond to a specific period of time. After selected time interval and each time step within the selected time interval is completed, a different time interval may be chosen for performing various actions using various electric power agents for an electric power generation environment. In Blocks 305-350, the predetermined time interval may then correspond to the time interval selected in Block 360 rather than Block 300.

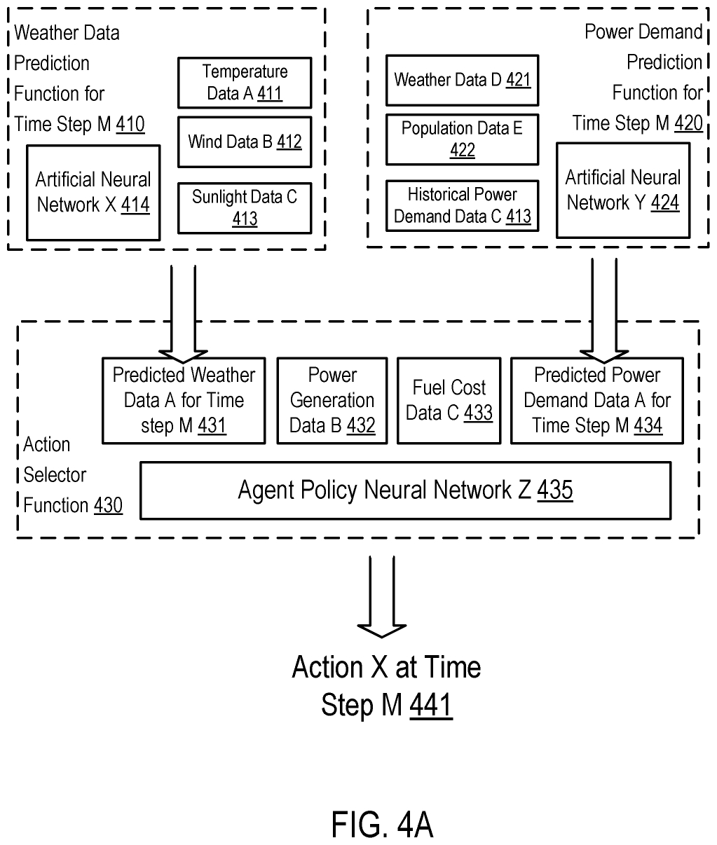

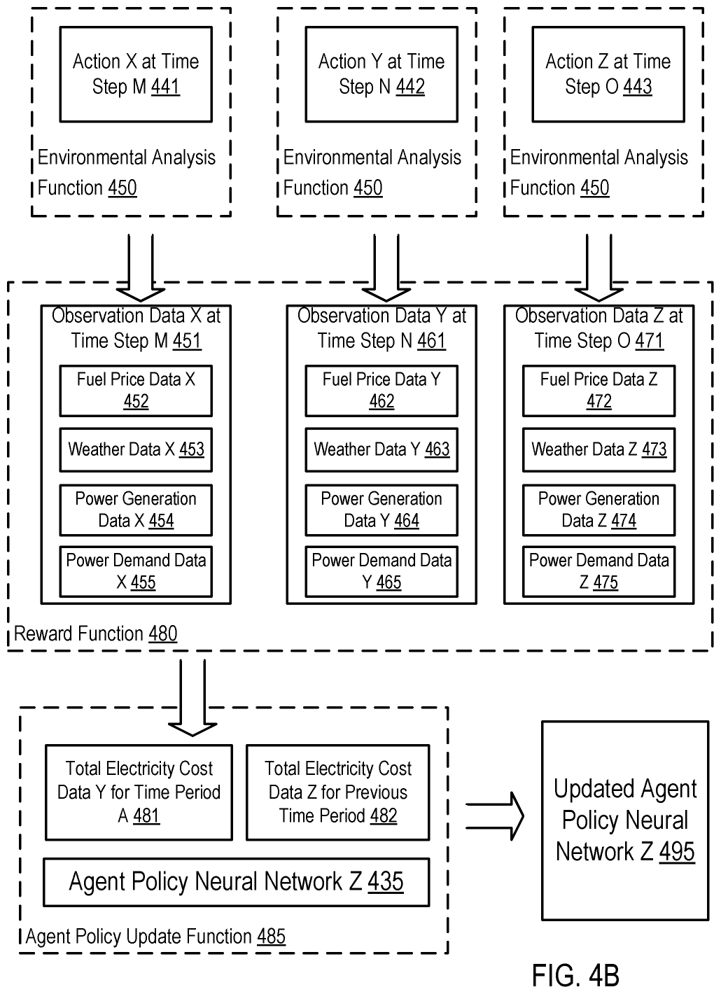

Turning to FIGS. 4A-4B, FIGS. 4A and 4B provide an example of selecting actions and updating an agent policy based on a deep reinforcement learning algorithm in accordance with one or more embodiments. The following example is for explanatory purposes only and not intended to limit the scope of the disclosed technology.

In FIG. 4A, an electric power manager (not shown) obtains temperature data A (411), wind data B (412), and sunlight data C (413) for a time step M. Using a weather data prediction function (410) for time step M, the electric power manager inputs the data (411, 412, 413) to an artificial neural network X (414) to determine predicted weather data A (431) for time step M. Likewise, the electric power manager also uses a power demand prediction function (420) for time step M using weather data D (421), population data E (422), and historical power demand data C (413) as inputs to an artificial neural network Y (424) to determine predicted power demand data A (434) for time step M.

Keeping with FIG. 4A, the electric power manager uses an action selector function (430) with the predicted weather data A (431), power generation data B (432), fuel cost data C (433), and predicted power demand data A (434) as inputs to an agent policy neural network Z (435). The agent policy neural network Z (435) subsequently outputs an action X (441) for time step M. The electric power manager subsequently implements action X (441) in an electric power distribution network.

Turning to FIG. 4B, the electric power manager analyses an electric power generation environment for the action X (441) at time step M, an action Y (442) at time step N, and an action Z (443) at time step M using an environmental analysis function (450). In particular, the environmental analysis function obtains relevant observation data for a respective time step, i.e., observation data X (451) for time step M, observation data Y (461) for time step N, and observation data Z (471) for time step O. More specifically, observation data X (451) includes fuel price data X (452), weather data X (453), power generation data X (454), and power demand data X (455). Likewise, observation data Y (461) includes fuel price data Y (462), weather data Y (463), power generation data Y (464), and power demand data Y (465). Finally, observation data Z (471) includes fuel price data Z (472), weather data Z (473), power generation data Z (474), and power demand data Z (475). The electric power manager then uses the observation data (451, 461, 471) as inputs to a reward function (480) that determines a reward value, i.e., total electric cost data Y (481) for a time period A that include time steps M, N, and O. Based on the reward value and an update agent policy function (485), the electric power manager then updates the agent policy neural network Z (435) using total electricity cost data Z (482) for the previous time period in order to generate an updated agent policy neural network Z (495). The updated agent policy neural network Z (495) may be used in the time steps in the next time interval for determining various actions for various electric power agents.

Embodiments may be implemented on a computer system. FIG. 5 is a block diagram of a computer system (502) used to provide computational functionalities associated with described algorithms, methods, functions, processes, flows, and procedures as described in the instant disclosure, according to an implementation. The illustrated computer (502) is intended to encompass any computing device such as a high performance computing (HPC) device, server, desktop computer, laptop/notebook computer, wireless data port, smart phone, personal data assistant (PDA), tablet computing device, one or more computer processors within these devices, or any other suitable processing device, including both physical or virtual instances (or both) of the computing device. Additionally, the computer (502) may include a computer that includes an input device, such as a keypad, keyboard, touch screen, or other device that can accept user information, and an output device that conveys information associated with the operation of the computer (502), including digital data, visual, or audio information (or a combination of information), or a GUI.

The computer (502) can serve in a role as a client, network component, a server, a database or other persistency, or any other component (or a combination of roles) of a computer system for performing the subject matter described in the instant disclosure. The illustrated computer (502) is communicably coupled with a network (530). In some implementations, one or more components of the computer (502) may be configured to operate within environments, including cloud-computing-based, local, global, or other environment (or a combination of environments).

At a high level, the computer (502) is an electronic computing device operable to receive, transmit, process, store, or manage data and information associated with the described subject matter. According to some implementations, the computer (502) may also include or be communicably coupled with an application server, e-mail server, web server, caching server, streaming data server, business intelligence (BI) server, or other server (or a combination of servers).

The computer (502) can receive requests over network (530) from a client application (for example, executing on another computer (502)) and responding to the received requests by processing the said requests in an appropriate software application. In addition, requests may also be sent to the computer (502) from internal users (for example, from a command console or by other appropriate access method), external or third-parties, other automated applications, as well as any other appropriate entities, individuals, systems, or computers.

Each of the components of the computer (502) can communicate using a system bus (503). In some implementations, any or all of the components of the computer (502), both hardware or software (or a combination of hardware and software), may interface with each other or the interface (504) (or a combination of both) over the system bus (503) using an application programming interface (API) (512) or a service layer (513) (or a combination of the API (512) and service layer (513). The API (512) may include specifications for routines, data structures, and object classes. The API (512) may be either computer-language independent or dependent and refer to a complete interface, a single function, or even a set of APIs. The service layer (513) provides software services to the computer (502) or other components (whether or not illustrated) that are communicably coupled to the computer (502). The functionality of the computer (502) may be accessible for all service consumers using this service layer. Software services, such as those provided by the service layer (513), provide reusable, defined business functionalities through a defined interface. For example, the interface may be software written in JAVA, C++, or other suitable language providing data in extensible markup language (XML) format or other suitable format. While illustrated as an integrated component of the computer (502), alternative implementations may illustrate the API (512) or the service layer (513) as stand-alone components in relation to other components of the computer (502) or other components (whether or not illustrated) that are communicably coupled to the computer (502). Moreover, any or all parts of the API (512) or the service layer (513) may be implemented as child or sub-modules of another software module, enterprise application, or hardware module without departing from the scope of this disclosure.

The computer (502) includes an interface (504). Although illustrated as a single interface (504) in FIG. 5, two or more interfaces (504) may be used according to particular needs, desires, or particular implementations of the computer (502). The interface (504) is used by the computer (502) for communicating with other systems in a distributed environment that are connected to the network (530). Generally, the interface (504 includes logic encoded in software or hardware (or a combination of software and hardware) and operable to communicate with the network (530). More specifically, the interface (504) may include software supporting one or more communication protocols associated with communications such that the network (530) or interface's hardware is operable to communicate physical signals within and outside of the illustrated computer (502).

The computer (502) includes at least one computer processor (505). Although illustrated as a single processor (505) in FIG. 5, two or more computer processors may be used according to particular needs, desires, or particular implementations of the computer (502). Generally, the computer processor (505) executes instructions and manipulates data to perform the operations of the computer (502) and any algorithms, methods, functions, processes, flows, and procedures as described in the instant disclosure.

The computer (502) also includes a memory (506) that holds data for the computer (502) or other components (or a combination of both) that can be connected to the network (530). For example, memory (506) can be a database storing data consistent with this disclosure. Although illustrated as a single memory (506) in FIG. 5, two or more memories may be used according to particular needs, desires, or particular implementations of the computer (502) and the described functionality. While memory (506) is illustrated as an integral component of the computer (502), in alternative implementations, memory (506) can be external to the computer (502).

The application (507) is an algorithmic software engine providing functionality according to particular needs, desires, or particular implementations of the computer (502), particularly with respect to functionality described in this disclosure. For example, application (507) can serve as one or more components, modules, applications, etc. Further, although illustrated as a single application (507), the application (507) may be implemented as multiple applications (507) on the computer (502). In addition, although illustrated as integral to the computer (502), in alternative implementations, the application (507) can be external to the computer (502).

There may be any number of computers (502) associated with, or external to, a computer system containing computer (502), each computer (502) communicating over network (530). Further, the term “client,” “user,” and other appropriate terminology may be used interchangeably as appropriate without departing from the scope of this disclosure. Moreover, this disclosure contemplates that many users may use one computer (502), or that one user may use multiple computers (502).

In some embodiments, the computer (502) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining first power generation data for an electric power generation environment,
wherein the electric power generation environment comprises a plurality of control systems coupled to a plurality of electric generator devices and a plurality of sensors configured to determine a plurality of electrical loads, and
wherein the plurality of electrical generator devices are configured to transmit electrical power over a plurality of power transmission lines to the plurality of electrical loads;
obtaining first acquired weather data for the electric power generation environment;
determining, by a computer processor, predicted weather data for a first predetermined time interval using a first artificial neural network and first acquired weather data;
obtaining, using the plurality of sensors, first acquired power demand data based on the plurality of electrical loads for the electric power generation environment;
determining, by the computer processor, predicted power demand data for the first predetermined time interval using a second artificial neural network and the first acquired power demand data;
determining, by the computer processor, a first action for an electric power agent based on an agent policy, the first power generation data, the predicted weather data, and the predicted power demand data, wherein the electric power agent is a first control system among the plurality of control systems; and
transmitting, by the computer processor and to the first control system, a first command to implement the first action during the first predetermined time interval.

2. The method of claim 1, further comprising:
obtaining first observation data regarding the electric power generation environment in response to the electric power agent performing the first action, wherein the first observation data comprises second power generation data, second acquired weather data, and second acquired power demand data;
determining a reward value using the first observation data and a reward function associated with the electric power agent;
updating the agent policy using a reinforcement learning algorithm to produce an updated agent policy; and
transmitting, to the first control system, a second command to implement a second action by the electric power agent for a second predetermined time interval,
wherein the second action is based on the updated agent policy and second observation data.

3. The method of claim 2, further comprising:
obtaining fuel price data for operating at least a portion of the plurality of electrical generator devices,
wherein the first observation data comprises the fuel price data, and
wherein the fuel price data is used to update the agent policy to produce the updated agent policy.

4. The method of claim 2,
wherein the reward function is based on a cost of electric power generation for a respective time interval, and
wherein the agent policy is updated based on a cost of electric power generation for the first predetermined time interval.

5. The method of claim 1,
wherein the agent policy is a third artificial neural network comprising an input layer, an output layer, and a plurality of hidden layers, and
wherein the first action is determined by the output layer based on observation data input to the input layer.

6. The method of claim 1,
wherein the plurality of electrical generator devices comprise one or more wind power devices in a predetermined region,
wherein the first acquired weather data comprises wind data that are acquired using a plurality of wind sensors in the predetermined region, and
wherein the predicted weather data is determined using the wind data.

7. The method of claim 1,
wherein the plurality of electrical generator devices comprise one or more solar generator devices in a predetermined region,
wherein the first acquired weather data comprises solar data that are acquired using a plurality of solarimeters in the predetermined region, and
wherein the predicted weather data is determined using the solar data.

8. The method of claim 1,
wherein the predicted weather data is determined using wind data for a predetermined region, solar data for the predetermined region, and temperature data for the predetermined region.

9. The method of claim 1,
wherein the first power generation data comprises transmission line data, ramping data, and power reserve data.

10. The method of claim 1, further comprising:
obtains training data regarding a plurality of electric power agents; and
updating, using the training data, the agent policy based on a loss function and a mismatch between the training data and third observation data regarding one or more electric power generation operations for one or more predetermined time intervals, and
wherein the updated agent policy comprises a plurality of policy parameters that are adjusted based on the mismatch.

11. The method of claim 1, further comprising:
obtaining, using a replay buffer, a plurality of electric power agent trajectories regarding a plurality of electric power agents; and
updating a reward function based on training data using a plurality of machine-learning epochs,
wherein the training data comprises the plurality of electric power agent trajectories.

12. The method of claim 1,
wherein the electric power generation environment is monitored using a supervisory control and data acquisition (SCADA) system, and
wherein the first command is transmitted by a control server that is a master node in the SCADA system.

13. A system, comprising:
a plurality of electrical generator devices comprising a wind power device, a solar generator device, and a fossil fuel power device;
a power substation network coupled to the plurality of electrical generator devices, wherein the power substation network comprises a plurality of sensors configured to determine a plurality of electrical loads;
a plurality of control systems coupled to the plurality of electrical generator devices; and
an electric power manager coupled to the plurality of control systems, the electric power manager comprising a computer processor, wherein the electric power manager is configured to perform a method comprising:
obtaining first power generation data for an electric power generation environment comprising the plurality of electrical generator devices and the plurality of control systems,
wherein the electric power generation environment comprises the plurality of control systems coupled to the plurality of electrical generator devices and the plurality of sensors, and
wherein the plurality of electrical generator devices are configured to transmit electrical power over a plurality of power transmission lines to the plurality of electrical loads;
obtaining first acquired weather data for the electric power generation environment;
determining predicted weather data for a first predetermined time interval using a first artificial neural network and first acquired weather data;
obtaining, using the plurality of sensors, first acquired power demand data based on the plurality of electrical loads for the electric power generation environment;
determining predicted power demand data for the first predetermined time interval using a second artificial neural network and the first acquired power demand data;
determining a first action for an electric power agent based on an agent policy, the first power generation data, the predicted weather data, and the predicted power demand data, wherein the electric power agent is a first control system among the plurality of control systems; and
transmitting, to the first control system, a first command to implement the first action during the first predetermined time interval.

14. The system of claim 13, wherein the method further comprises:
obtaining first observation data regarding the electric power generation environment in response to the electric power agent performing the first action, wherein the first observation data comprises second power generation data, second acquired weather data, and second acquired power demand data;
determining a reward value using the first observation data and a reward function associated with the electric power agent;
updating the agent policy using a reinforcement learning algorithm to produce an updated agent policy; and
transmitting, to the first control system, a second command to implement a second action by the electric power agent for a second predetermined time interval,
wherein the second action is based on the updated agent policy and second observation data.

15. The system of claim 14, wherein the method further comprises:
obtaining fuel price data for operating at least a portion of the plurality of electrical generator devices,
wherein the first observation data comprises the fuel price data, and
wherein the fuel price data is used to update the agent policy to produce the updated agent policy.

16. The system of claim 14,
wherein the reward function is based on a cost of electric power generation for a respective time interval, and
wherein the agent policy is updated based on a cost of electric power generation for the first predetermined time interval.

17. The system of claim 13,
wherein the wind power device is disposed in a predetermined region,
wherein the first acquired weather data comprises wind data that are acquired using a plurality of wind sensors in the predetermined region, and
wherein the predicted weather data is determined using the wind data.

18. The system of claim 13,
wherein the solar generator device is disposed in a predetermined region,
wherein the first acquired weather data comprises solar data that are acquired using a plurality of solarimeters in the predetermined region, and
wherein the predicted weather data is determined using the solar data.

19. The system of claim 13,
wherein the first power generation data comprises transmission line data, ramping data, and power reserve data.

20. The system of claim 13,
wherein the agent policy is a third artificial neural network comprising an input layer, an output layer, and a plurality of hidden layers, and
wherein the first action is determined by the output layer based on observation data input to the input layer.
